(19) United States
(12) Patent Application Publication
(10) Pub. No.: US 2002/0005904 A1
(43) Pub. Date: Jan. 17, 2002

(54) Method for pixel correction

(76) Inventor: Sunetra K. Mendis, Palo Alto, CA (US)

Correspondence Address: J.C. PATENTS, Inc., Suite 114, 1340 Reynolds Ave., Irvine, CA, 92614, US

(21) Appl. No.: 09/898,114

(22) Filed: Jul. 2, 2001

Related U.S. Application Data
(60) Provisional application No. 60/217,532, filed on Jul. 12, 2000.

(51) Int. Cl. H04N 9/64

(52) U.S. Cl. 348/246

(57) ABSTRACT

A pixel correction algorithm is provided in the invention for an image sensing device. In the invention, the pixel correction algorithm is modified to accommodate hard and soft bad pixels. In the invention, the “hard” bad pixels indicate that the pixels are defective under all operating conditions. The “soft” bad pixels indicate that the pixels will appear defective only under certain operating conditions. In the correction algorithm, the hard bad pixel is always replaced regardless of their value or operating conditions. The soft bad pixel is replaced only if its value is “significantly” different from the replacement value. The allowable variation can be programmable or fixed. The algorithm is adaptive as it replaces bad pixels only when conditions make them appear bad.

### BACKGROUND OF THE INVENTION

1. Field of the Invention

The present invention relates to a pixel correction method for a detected bad of a pixel image sensing device. More particularly, the present invention relates to pixel correction method for a detected bad of a pixel image sensing device, which is adaptive as is replaces bad pixels only when conditions make them appear bad.

2. Description of the Related Art

Charge coupled imaging devices and charge injection imaging devices comprising a plurality of photosensitive elements arranged in a matrix of rows and columns are well known in the art. Each of the photosensitive elements comprises row and column electrodes. All of the row electrodes in each row are in common connection with respect to each other, and all of the column electrodes in each column are in common connection with respect to each other also. Incident scene light operates to photogenerate minority charge carriers in potential wells under each pair of electrodes in each photosensitive element. The photogenerated charges may be transferred out of the imager as a pulse train of analog voltages by well known scanning techniques. The analog signals may thereafter be color or gamma corrected digitized and stored in a buffer memory.

A variety of techniques are known for correcting defects in a video output signal from an image sensing device such as a photosensor array. Similarly, methods have been devised in which a threshold detector looks at the combined image pulse and the fixed pattern noise (or dark current) of the pixel. If a given threshold is exceeded the pixel information is discarded and some other value is substituted therein. An example of such an approach is shown in Endo et al., U.S. Pat. No. 4,567,525. A problem with this approach is similar to that encountered with frequency sensitive systems in which a sharp transition or increase in the pixel response may be due to a line in the picture as opposed to a bad element.

In Pape et al., U.S. Pat. No. 5,047,863, describes an online or real time method of detecting bad pixels without ambiguity. In the patent if dark pixel data from an imaging device does not exceed a threshold indicative of a defect, the pixel data from the scene is stored in a buffer. If the dark pixel data exceeds a threshold the image scene data from a prior pixel is entered in the buffer whereby pixel correction is achieved.

However, the nature or severity of pixel defects can change with operating conditions. For example, the defect of leakage can change with temperature, exposure time or gain setting. Junction leakage typically doubles every 10° C. Long exposure time will show more hot pixels than short exposure. Higher gain will also make leakage more visible. The best case operating conditions would be low temperature, low gain and short exposure time. The worst case is high temperature, high gain and long exposure time. If the bad pixels addresses are recorded under best conditions, pixel correction will be fully effective only under best case conditions. If conditions become worse, “new” bad pixel will appear and degrade image quality. If the bad pixel addresses are recorded under worst case conditions, no new bad pixels will appear under typical or best case conditions. However, under typical or best case conditions, some pixel values that do not appear bad will also be replaced by the bad pixel correction algorithm.

This indicates that there are two types of bad pixels. One will be termed “hard” bad pixels. These are the pixels that are defective under all operating conditions. The other is termed “soft” and indicates that it will appear defective only under certain operating condition such as high temperature, high gain or long exposure time.

### SUMMARY OF THE INVENTION

The present invention provides a pixel correction algorithm. The pixel correction algorithm is modified to accommodate hard and soft bad pixels. The “hard” bad pixels indicate that the pixels are defective under all operating conditions. The “soft” bad pixels indicate that the pixels will appear defective only under certain operating conditions. In the correction algorithm, the hard bad pixel is always replaced regardless of their value or operating conditions. The Soft bad pixel is replaced only if its value is “significantly” different from the replacement value. The allowable variation can be programmable or fixed. The algorithm is adaptive as it replaces bad pixels only when conditions make them appear bad.

To achieve these and other advantages and in accordance with the purpose of the invention, as embodied and broadly described herein, the invention provides a pixel correction method for a detected bad of a pixel image sensing device, the method comprising: determining types of the detected bad pixel, wherein the types of the bad pixels includes a first-type bad pixel and a second-type bad pixel, if the detected bad pixel is the first-type bad pixel, replacing a value of the first-type bad pixel with a replacement value; if the detected bad pixel is the second-type bad pixel, comparing a value of the second-type bad pixel with the replacement value to determine a different value between the value of the second-type bad pixel and the replacement value; and determining whether the different value is larger than a predetermined value, if the different value is larger than a predetermined value, replacing the value of the second-type bad pixel with the replacement value.

The pixel correction method as above described, the first-type bad pixel is a pixel that is defective under all operating conditions, and the second-type bad pixel is a pixel that is defective only under some specific operating conditions.

The pixel correction method as above described, the predetermined value is determined according to operating conditions such as a temperature of operation of the image sensing device, an exposure time or a gain setting of the image sensing device.

To achieve these and other advantages and in accordance with the purpose of the invention, as embodied and broadly described herein, the invention provides a pixel correction method for a detected bad of a pixel image sensing device, the method comprising: determining types of the detected bad pixel, wherein the types of the bad pixels includes a hard bad pixel and a soft bad pixel, if the detected bad pixel is the hard bad pixel, replacing a value of the hard bad pixel with a replacement value; if the detected bad pixel is the soft bad pixel, comparing a value of the soft bad pixel with the replacement value to determine a different value between the value of the soft bad pixel and the replacement value; and determining whether the different value is larger than a predetermined value, if the different value is larger than a predetermined value, replacing the value of the soft bad pixel with the replacement value.

The pixel correction method as above described, the first-type bad pixel is a pixel that is defective under all operating conditions, and the second-type bad pixel is a pixel that is defective only under some specific operating conditions.

The pixel correction method as above described, the predetermined value is determined according to operating conditions such as a temperature of operation of the image sensing device, an exposure time or a gain setting of the image sensing device.

It is to be understood that both forgoing general description and the following detailed description are exemplary, and intended to provide further explanation of the invention as claimed.

### BRIEF DESCRIPTION OF THE DRAWINGS

The accompanying drawings are included to provide a further understanding of the invention, and are incorporated in and constitute a part of this specification. The drawing illustrate embodiments of the invention and, together with the description, serve to explain the principles if the invention. In the drawings,

FIG. 1 is a flowchart of a pixel correction method of a preferred embodiment of the present invention.

### DESCIPTION OF THE PREFERRED EMBODIMENT

A pixel correction algorithm is provided in the invention for an image sensing device. In the invention, the pixel correction algorithm is modified to accommodate hard and soft bad pixels. In the invention, the “hard” bad pixels indicate that the pixels are defective under all operating conditions. The “soft” bad pixels indicate that the pixels will appear defective only under certain operating conditions. In the correction algorithm, the hard bad pixel is always replaced regardless of their value or operating conditions. The soft bad pixel is replaced only if its value is “significantly” different from the replacement value. The allowable variation can be programmable or fixed. The algorithm is adaptive as it replaces bad pixels only when conditions make them appear bad.

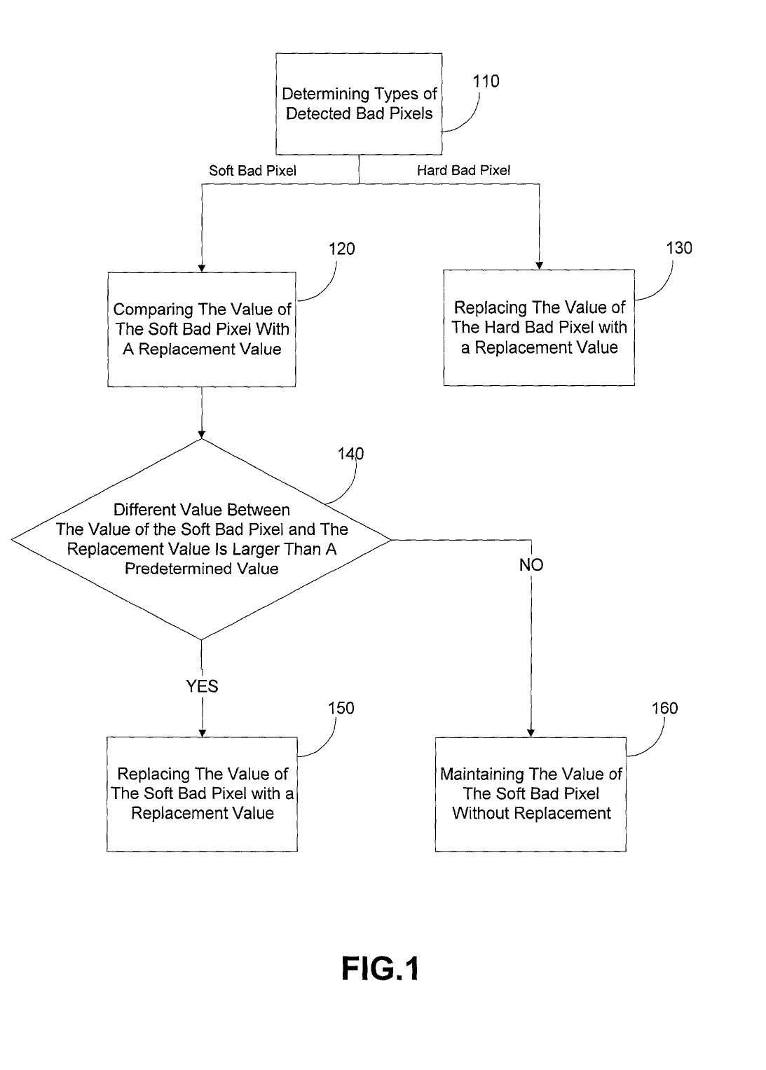

The pixel correction algorithm of a preferred embodiment of the invention is shown in FIG. 1. In step 110, bad pixels are detected and types of the bad pixels are determined. The standard for determining the types of the bad pixels are determined under which conditions these pixels will be regarded as defective. For example, “hard” bad pixels indicate that the pixels are defective under all operating conditions and “soft” bad pixels indicate that the pixels will appear defective only under certain operating conditions such as a temperature while the image sensing device operates, an exposure time or a gain setting of the image sensing device.

In step 130, if the detected bad pixels are determined “hard” bad pixels, the value of the hard bad pixel is replaced with a replacement value. The replacement value can be, for example, an offset value corresponding to a generated dark current. The replacement value can also be, for example, a prior pixel value to replace the value of the hard bad pixel.

In step 120, if the detected bad pixels are determined “soft” bad pixels, the value of the soft bad pixel is compared with a replacement value. The replacement value can be, for example, an offset value corresponding to a generated dark current. The replacement value can also be, for example, a prior pixel value to replace the value of the hard bad pixel. In the following step 140, determining whether a different value between the value of the soft bad pixel and the replacement value is larger than a predetermined value. If yes, the value of the soft bad pixel is replaced with the replacement value, as shown in step 150. If no, the value of the soft bad pixel is maintained without replacement, as shown in step 160. That means that the soft bad pixel will be replaced only if its value is significantly different from the replacement value.

The predetermined value as described in step 140 can be fixed or variable. The variation of the predetermined value can be determined according to operating conditions such as a temperature while the image sensing device operates, an exposure time or a gain setting of the image sensing device. The variation of the predetermined value can also be programmable according to design requirements.

As described above, the pixel correction algorithm can be modified adaptively to accommodate hard and soft bad pixels. In the correction algorithm, the hard bad pixel is always replaced regardless of their value or operating conditions. The soft bad pixel is replaced only if its value is “significantly” different from the replacement value. The allowable variation can be programmable or fixed. The algorithm is adaptive as is replaces bad pixels only when conditions make them appear bad.

It will be apparent to those skilled in the art that various modifications and variations can be made to the structure of the present invention without departing from the scope or spirit of the invention. In view of the forgoing, it is intended that the present invention cover modification and variation of this invention provided they fall within the scope of the following claims and their equivalents.

What is claimed is:

1. A pixel correction method for a detected bad of a pixel image sensing device, the method comprising:
determining types of the detected bad pixel, wherein the types of the bad pixels includes a first-type bad pixel and a second-type bad pixel,
if the detected bad pixel is the first-type bad pixel,
replacing a value of the first-type bad pixel with a replacement value;
if the detected bad pixel is the second-type bad pixel,
comparing a value of the second-type bad pixel with the replacement value to determine a different value between the value of the second-type bad pixel and the replacement value; and
determining whether the different value is larger than a predetermined value,
if the different value is larger than a predetermined value, replacing the value of the second-type bad pixel with the replacement value.

2. The pixel correction method as claimed in claim 1, wherein the first-type bad pixel is a pixel that is defective under all operating conditions, and the second-type bad pixel is a pixel that is defective only under some specific operating conditions.

3. The pixel correction method as claimed in claim 1, wherein the predetermined value is determined according to operating conditions.

4. The pixel correction method as claimed in claim 3, wherein the operating conditions include a temperature of operation of the image sensing device.

5. The pixel correction method as claimed in claim 3, wherein the operating conditions include an exposure time of the image sensing device.

6. The pixel correction method as claimed in claim 3, wherein the operating conditions include a gain setting of the image sensing device.

7. A pixel correction method for a detected bad of a pixel image sensing device, the method comprising:
determining types of the detected bad pixel, wherein the types of the bad pixels includes a hard bad pixel and a soft bad pixel,
if the detected bad pixel is the hard bad pixel,
replacing a value of the hard bad pixel with a replacement value;
if the detected bad pixel is the soft bad pixel,
comparing a value of the soft bad pixel with the replacement value to determine a different value between the value of the soft bad pixel and the replacement value; and
determining whether the different value is larger than a predetermined value,
if the different value is larger than a predetermined value, replacing the value of the soft bad pixel with the replacement value.

8. The pixel correction method as claimed in claim 7, wherein the hard bad pixel is a pixel that is defective under all operating conditions, and the soft bad pixel is a pixel that is defective only under some specific operating conditions.

9. The pixel correction method as claimed in claim 7, wherein the predetermined value is determined according to operating conditions.

10. The pixel correction method as claimed in claim 9, wherein the operating conditions include a temperature of operation of the image sensing device.

11. The pixel correction method as claimed in claim 9, wherein the operating conditions include an exposure time of the image sensing device.

12. The pixel correction method as claimed in claim 9, wherein the operating conditions include a gain setting of the image sensing device.
